(19) United States
(12) Patent Application Publication
(10) Pub. No.: US 2007/0147447 A1
(43) Pub. Date: Jun. 28, 2007

(54) Light emitting device having thermal controller

(75) Inventor: Jong-hwa Won, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/521,512

(22) Filed: Sep. 15, 2006

(30) Foreign Application Priority Data
Dec. 24, 2005 (KR) 10-2005-0129139

(51) Int. Cl. H01S 3/04; H01S 3/00

(52) U.S. Cl. 372/36; 372/34; 372/38.02

(57) ABSTRACT

A light emitting apparatus which has reduced power consumption is provided. The light emitting apparatus includes a light emitting device and a thermoelectric cooler which cools the light emitting device. The light emitting device and the thermoelectric cooler are driven by a single voltage source. The light emitting apparatus operates the thermoelectric cooler using a current which is normally consumed as heat energy by a bias resistor in a circuit. Accordingly, the circuit is simplified and power consumption is reduced.

### CROSS-REFERENCE TO RELATED PATENT APPLICATION

This application claims priority from Korean Patent Application No. 10-2005-0129139, filed on Dec. 24, 2005, in the Korean Intellectual Property Office, the disclosure of which is incorporated herein in its entirety by reference.

### BACKGROUND OF THE INVENTION

1. Field of the Invention

Apparatuses consistent with the present invention relate to a light emitting device having a thermal controller, and more particularly, to a light emitting device having a simplified structure and a reduced power consumption.

2. Description of the Related Art

A light emitting device such as a laser diode is susceptible to a change in temperature when in operation. The output of the light emitting device is almost directly proportional to current and inversely proportional to temperature. Therefore, a thermal stabilizer such as a thermoelectric cooler (TEC) is added to a light emitting device to stabilize the output of light emitting devices that are susceptible to a change in temperature and to address this problem. As is well known in the art, the light emitting device is mounted on a heat sink where the thermoelectric cooler is assembled. The thermoelectric cooler is controlled by a sensor that detects the temperature or the light output of the light emitting device and a controller that controls the current flowing through the thermoelectric cooler using the detected temperature or light output signal.

In a related art light emitting apparatus, a circuit for driving the light emitting device and a circuit for driving the thermoelectric cooler are independent of each other. FIG. 1 is a circuit diagram of the related art light emitting apparatus including a thermoelectric cooler serving as a temperature stabilizer.

FIG. 1 illustrates an example of a related art light emitting apparatus that has a light emission amount controlled by an input signal.

The light emitting device LD is a part of a modulator, and is disposed between a driving voltage terminal Vcc and a collector of a first transistor Q1. A current flowing through the light emitting device LD is controlled by a modulating signal or a driving signal applied to a base of the first transistor Q1.

A cooler, which here is a thermoelectric cooler (TEC), operating as part of a temperature controller for cooling the light emitting device LD, is connected to a collector of a second transistor Q2 and a driving voltage Vcc is applied to the cooler. A current flowing through the thermoelectric cooler (TEC) is controlled by a temperature control signal applied to a base of the second transistor Q2. Here, the temperature control signal is obtained from an output signal of the light emitting device or from a temperature detected from the light emitting device. Reference numerals R1 and R2 indicate bias resistors which determine bias voltages of the first and second transistors Q1 and Q2, respectively. In FIG. 1, except for the bias resistors R1 and R2, general bias resistors required to drive the transistors are not shown.

As illustrated in FIG. 1, the thermoelectric cooler (TEC) operates by a current, as does the light emitting device (LD), and thus a large operating current is required. That is, the total current of the light emitting apparatus approximately corresponds to the sum of a current I_{LD} of the light emitting device and a current I_{TEC} of the temperature controller. The main drawback of the related art light emitting apparatus is that the total current required is large because the light emitting device and the temperature controller both require a large amount of current. In the case of a portable electronic product that does not use a wall power source, the light emitting apparatus would require a large-capacity battery, thereby increasing the unit cost of the product as well as limiting the portability of the product.

In addition to the related art light emitting apparatus illustrated in FIG. 1, a related art light emitting apparatus of a more complicated structure, wherein a separate circuit for determining a bias current for a light emitting device is added to a driver of the light emitting device, also has a temperature controller which uses a separate voltage source. Therefore, the related art light emitting apparatus also has a drawback due to high power consumption, as described above.

### SUMMARY OF THE INVENTION

An aspect of the present invention provides a light emitting apparatus having a reduced total power consumption.

An aspect of the present invention also provides a light emitting apparatus which has a reduced number of components and a simplified structure.

According to an aspect of the present invention, there is provided a light emitting apparatus including: a light emitting device and a thermoelectric cooler which cools the light emitting device, wherein the light emitting device and the thermoelectric cooler are driven by a single voltage source. That is, the thermoelectric cooler in the light emitting apparatus does not require a separate voltage source and is disposed at a light emitting device driver such that it is supplied with a current from a voltage source used to drive the light emitting device.

According to another aspect of the present invention, there is provided a light emitting apparatus including: a light emitting device disposed on a circuit connected to a voltage source; a light emitting device driver which modulates a current flowing through the circuit by an external signal to control a light-emission of the light emitting device; and a thermoelectric cooler disposed on the circuit, together with the light emitting device, to operate by a current which has passed through the light emitting device.

According to another aspect of the present invention, there is provided a light emitting apparatus including: a light emitting device disposed on a circuit connected to a voltage source; a bias controller which determines a bias current applied to the light emitting device; a light emitting device driver which generates a modulating current for the light emitting device to control a light emission of the light emitting device in response to an external signal; and a thermoelectric cooler disposed on the circuit, together with the light emitting device, which operates by a current that passes through the light emitting device.

### BRIEF DESCRIPTION OF THE DRAWINGS

The above and other features and advantages of the present invention will become more apparent by describing in detail exemplary embodiments thereof with reference to the attached drawings in which:

FIG. 1 is a circuit diagram of a related art light emitting apparatus which includes a thermoelectric cooler which serves as a temperature stabilizer;

FIG. 2 is a circuit diagram of a light emitting apparatus according to an exemplary embodiment of the present invention;

FIG. 3 is a circuit diagram of a light emitting apparatus according to another exemplary embodiment of the present invention; and

FIG. 4 is a circuit diagram of a light emitting apparatus according to another exemplary embodiment of the present invention.

### DETAILED DESCRIPTION OF THE INVENTION

The present invention will now be described more fully with reference to the accompanying drawings, in which exemplary embodiments of the invention are shown.

FIG. 2 is a circuit diagram of a light emitting apparatus according to an exemplary embodiment of the present invention. The light emitting apparatus illustrated in FIG. 2 includes a light emitting device driver that includes a transistor Q1 which controls a light output of a light emitting device LD by modulating a current flowing through the light emitting device LD by an external signal Vin (also referred to as a modulating signal).

Referring to FIG. 2, a modulating signal Vin is input to a base of a bias transistor Q1, and a light emitting device LD is connected to a collector of the transistor Q1 wherein a drive voltage terminal Vcc is connected to the light emitting device. A thermoelectric cooler (TEC) is connected to an emitter of the transistor Q1. The thermoelectric cooler also serves as an emitter bias resistor for the transistor Q1.

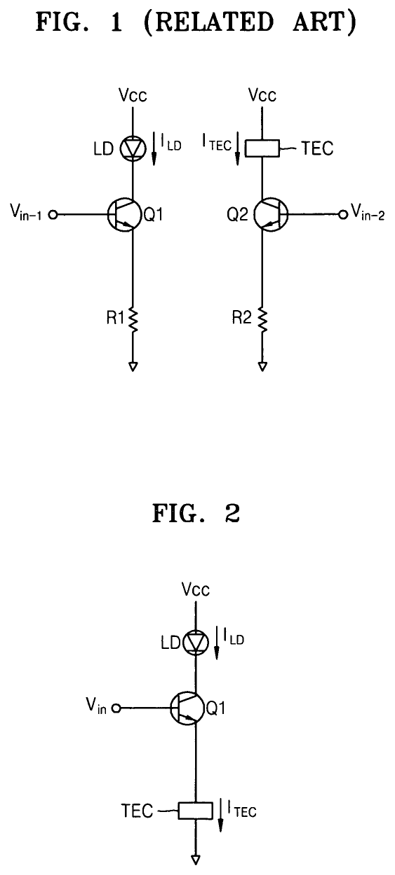

According to this structure, the thermoelectric cooler (TEC) uses a current for thermoelectric cooling which would be consumed as heat energy by the emitter bias resistor R1 of FIG. 1. More specifically, a current flowing through the light emitting device is changed by a signal input to a base terminal, for example, a driving signal or a modulating signal, and thus the light emitting device LD emits light while operating in response to the driving signal. At this point, the thermoelectric cooler (TEC) connected to the emitter of the transistor Q1 determines a specific emitter bias voltage to be applied to the transistor Q1. Here, a current I_{LD} of the light emitting device is approximately the same as a current I_{TEC} of the thermoelectric device. Accordingly, during the operation of the light emitting device, the thermoelectric cooler (TEC) not only serves as a bias resistor of the transistor Q1 but also cools the light emitting device LD. A structure of the light emitting apparatus according to exemplary embodiments of the present invention does not require temperature control by feedback, and thus is adequate for a light emitting apparatus that uses the transistor as a simple switch and that needs to generate an output of light having a constant intensity.

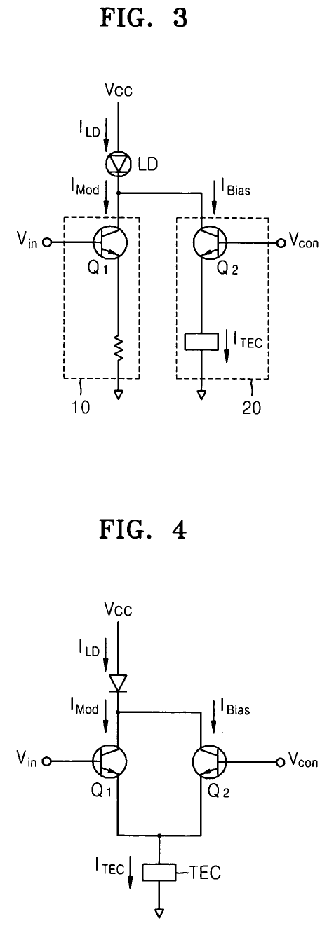

FIG. 3 is a circuit diagram of a light emitting apparatus according to another exemplary embodiment of the present invention. Referring to FIG. 3, the light emitting apparatus has a structure wherein a bias current and a modulating current flowing through a light emitting device can be separately controlled.

The light emitting apparatus illustrated in FIG. 3 includes a bias controller 20 which determines a constant or variable bias current for the light emitting device LD by using a bias control signal and a light emitting device driver (or a modulator) 10 generating a modulating current for modulating a light output of the light emitting device LD.

The light emitting device driver 10 includes a first transistor Q1, the light emitting device LD, and an emitter bias resistor R1. The first transistor Q1 includes a base to which a driving signal or a modulating signal Vin is input and a collector which is connected to the light emitting device LD wherein a driving voltage Vcc is input to the light emitting device LD.

In the bias controller 20, a collector of a second transistor Q2 is connected to the collector of the first transistor Q1. A thermoelectric cooler (TEC) serving as a bias resistor of the second transistor Q2 is connected to an emitter of the second transistor Q2. A bias current control signal Vcon, for example, a dynamic control signal or a predetermined constant voltage is applied to a base of the second transistor Q2.

According to this structure, a bias current for the light emitting device LD is determined by the second transistor Q2 of the bias controller 20. Also, a light output of the light emitting device LD is controlled by the first transistor Q1 in response to the driving signal or the modulating signal Vin.

The bias current is maintained around an operating point (or a biasing point) of the light emitting device LD. A modulating current I_{MOD} for controlling a light output of the light emitting device LD is generated by the second transistor Q2. Accordingly, if the driving signal Vin is not input to the first transistor Q1 when the light emitting device LD is biased by the bias controller 20, the modulating current I_{MOD} is not generated, and thus light emission is not generated. However, a slight amount of light emission may be generated by increasing the bias current above the operating point of the light emitting device LD.

That is, the light emitting device LD operates in response to the modulating signal or a driving signal Vin input to the base of the first transistor Q1 when the light emitting device LD is biased by the bias controller 20 such that the modulating current I_{MOD} is generated, the bias current I_{Bias} and the modulating current I_{MOD} are applied to the light emitting device LD which thus emits a light output. The thermoelectric cooler (TEC) cools the light emitting device LD through a thermoelectric conversion while the light emitting device LD operates in response to the modulating signal.

The unique feature of the light emitting apparatus illustrated in FIG. 3 is that since the emitter bias resistor of the second transistor Q2 is substituted with the thermoelectric cooler (TEC), a current consumed by a bias resistor in a related art structure is used for thermoelectric cooling of the light emitting device LD in the apparatus of FIG. 3. Consequently, the thermoelectric cooler (TEC) determines an emitter bias voltage for an operation of the second transistor Q2, and cools the light emitting device LD through a thermoelectric conversion of the current flowing through the light emitting device LD and the second transistor Q2.

FIG. 4 is a circuit diagram of a light emitting apparatus according to another exemplary embodiment of the present invention. The exemplary embodiment of FIG. 4 comprises a modified circuit of the light emitting apparatus illustrated in FIG. 3.

Referring to FIG. 4, emitters of a first transistor Q1 and a second transistor Q2 are connected together, and a thermoelectric cooler, which is a common emitter bias device, is connected between the emitters of the first transistor Q1 and the second transistor Q2. In the light emitting apparatus illustrated in FIG. 4, the first transistor Q1 and the second transistor Q2 are arranged in a symmetrical structure, and a light emitting device LD is connected between the collectors of the first transistor Q1 and the second transistor Q2. Accordingly, a current I_{TEC} flowing through the thermoelectric cooler (TEC) is approximately the same as the sum of a modulating current I_{MOD} generated by the first transistor Q1 and a bias current I_{Bias} generated by the second transistor Q2, and thus currents flowing through the light emitting device LD and the thermoelectric cooler (TEC) are approximately the same. The thermoelectric cooler (TEC) according to this exemplary embodiment determines a bias voltage of the first and the second transistors Q1 and Q2 and cools the light emitting device LD through thermoelectric cooling. In the light emitting apparatus illustrated in FIG. 4, a bias current control signal Vcon is applied to a base of the second transistor Q2. Therefore, a constant voltage for a constant bias current or a dynamic voltage for a dynamic bias current may be applied.

In the light emitting apparatus illustrated in FIG. 3 and FIG. 4, the temperature or the light output of the light emitting device LD detected by using a feedback control signal may be applied to the base of the second transistor Q2 as a bias current control signal Vcon for controlling a bias current. The process of detecting a temperature or a light output of a device and using this as a feedback signal is well known, and therefore a specific description about the process will be omitted. When a bias current dynamically varies in response to the feedback signal, an input for the light emitting device driver may vary accordingly, and another input control signal may be used with reference to the feedback signal.

As described above, the light emitting apparatus of the present invention has a structure where the thermoelectric cooler is provided in the bias controller for controlling the bias current for the light emitting device driver or the light emitting device. Also, the thermoelectric cooler of the present invention replaces the bias resistor of the related art light emitting apparatus such that the energy lost as heat energy in the bias resistor of the related art light emitting apparatus is instead used for a thermoelectric cooling in the exemplary embodiments of the present invention. According to the exemplary embodiments of the present invention, the entire structure of the light emitting apparatus is simplified, and the total power consumption thereof is reduced.

The exemplary embodiments of the present invention may be applied to a laser light emitting apparatus requiring a stable output and a stable temperature, and is also suitable for application to the portable laser image display.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A light emitting apparatus comprising:
a light emitting device; and
a thermoelectric cooler which cools the light emitting device,
wherein the light emitting device and the thermoelectric cooler are driven by a single voltage source.

2. The light emitting apparatus of claim 1, wherein the light emitting device is a laser diode.

3. The light emitting apparatus of claim 1, further comprising a light emitting device driver which controls a light output of the light emitting device by modulating an input signal.

4. The light emitting apparatus of claim 3, wherein the light emitting device driver comprises a transistor which controls a current applied to the light emitting device, and the thermoelectric cooler is provided as a bias device of the transistor.

5. The light emitting apparatus of claim 4, wherein the light emitting device is connected to a collector of the transistor and the thermoelectric cooler is connected to an emitter of the transistor such that the thermoelectric cooler is disposed on a current flow path that passes through the light emitting device.

6. A light emitting apparatus comprising:
a light emitting device disposed on a circuit connected to a voltage source;
a bias controller which determines a bias current applied to the light emitting device;
a light emitting device driver which generates a modulating current for the light emitting device to control a light emission of the light emitting device in response to an external signal; and
a thermoelectric cooler disposed on the circuit, together with the light emitting device, which operates by a current that passes through the light emitting device.

7. The light emitting apparatus of claim 6, wherein the bias controller comprises a transistor which controls the bias current applied to the light emitting device, and
wherein a collector of the transistor in the bias controller is connected to the light emitting device and an emitter of the transistor in the bias controller is connected to the thermoelectric cooler.

8. The light emitting apparatus of claim 6, wherein the light emitting device driver comprises a transistor with an input terminal which receives a light output control signal for generating the modulating signal.

9. The light emitting apparatus of claim 7, wherein the light emitting device driver comprises a transistor with an input terminal which receives a light output control signal for generating the modulating signal.

10. The light emitting apparatus of claim 8, wherein an emitter of the transistor in the light emitting device driver is connected to an emitter of a transistor in the bias controller, and the thermoelectric cooler is connected between the emitter of the transistor in the light emitting device driver and the emitter of the transistor in the bias controller.

11. The light emitting apparatus of claim 9, wherein an emitter of the transistor in the light emitting device driver is connected to an emitter of the transistor in the bias controller, and the thermoelectric cooler is connected between the emitter of the transistor in the light emitting device driver and the emitter of the transistor in the bias controller.

12. The light emitting apparatus of claim 6, wherein the light emitting device is a laser diode.

13. The light emitting apparatus of claim 7, wherein the light emitting device is a laser diode.
